(19) United States
(12) Patent Application Publication
(10) Pub. No.: US 2024/0242324 A1
(43) Pub. Date: Jul. 18, 2024

(54) STOP LINE SEARCHING DEVICE

(71) Applicant: TOYOTA JIDOSHA KABUSHIKI KAISHA, Toyota-shi (JP)

(72) Inventor: Yoshitaka KIJIMA, Toyota-shi (JP)

(73) Assignee: TOYOTA JIDOSHA KABUSHIKI KAISHA, Toyota-shi (JP)

(21) Appl. No.: 18/486,423

(22) Filed: Oct. 13, 2023

(30) Foreign Application Priority Data
Jan. 16, 2023 (JP) 2023-004468

(51) Int. Cl. G06T 7/00

(52) U.S. Cl. CPC G06T 7/0002; G06T 2207/30256

(57) ABSTRACT

The stop line searching device includes: an image acquisition unit that acquires an image obtained by capturing an image of a front side of the own vehicle; a traffic light detection unit that detects a traffic light installed at an intersection in front of the own vehicle based on the image; and a setting unit that sets a stop line searching area for searching for a stop line related to the intersection, based on a detection result indicating whether or not a front side traffic light on the front side of the intersection as viewed from the own vehicle is detected by the traffic light detection unit, when the rear side traffic light on the rear side of the intersection as viewed from the own vehicle is detected by the traffic light detection unit.

### CROSS-REFERENCE TO RELATED APPLICATION

This application claims priority to Japanese Patent Application No. 2023-004468 filed on Jan. 16, 2023, incorporated herein by reference in its entirety.

### BACKGROUND

### 1. Technical Field

The present disclosure relates to a technical field of a stop line searching device.

### 2. Description of Related Art

As a device of this type, for example, a device that shifts to a stop line recognition mode when a traffic light in front of a vehicle traveling road recognized from an image is a red signal has been proposed (see Japanese Unexamined Patent Application Publication No. 2011-123613 (JP 2011-123613 A)). Other related art documents include Japanese Unexamined Patent Application Publication No. 2021-033772 (JP 2021-033772 A).

### SUMMARY

When a stop line is recognized from an image, there is a possibility that a different line from the stop line may be erroneously recognized as the stop line depending on the state of a road surface appearing in the image, and there is room for improvement in the technology described in the related art document.

The present disclosure has been made in view of the above circumstances, and providing a stop line searching device capable of appropriately searching for a stop line is an issue.

A stop line searching device according to an aspect of the present disclosure includes:
an image acquisition unit for acquiring an image obtained by photographing an area in front of an own vehicle;
a traffic light detection unit for detecting a traffic light installed at an intersection in front of the own vehicle based on the image; and
a setting unit for setting a stop line searching area for searching for a stop line for the intersection, based on a detection result indicating whether a closer-side traffic light on a closer side of the intersection as viewed from the own vehicle is detected by the traffic light detection unit, when a further-side traffic light on a further side of the intersection as viewed from the own vehicle is detected by the traffic light detection unit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a vehicle according to an embodiment;

FIG. 2 is a flow chart illustrating an operation of ECU according to the embodiment;

FIG. 3A is a diagram illustrating an example of a stop line searching area;

FIG. 3B is a diagram illustrating an example of a stop line searching area;

FIG. 4A is a diagram showing an example of a stop line searching area according to a first modification;

FIG. 4B is a diagram showing an example of a stop line searching area according to a first modification;

FIG. 5A is a diagram showing an example of the stop line searching area concerning a second modification; and

FIG. 5B is a diagram illustrating an example of a stop line searching area according to a second modification.

### DETAILED DESCRIPTION OF EMBODIMENTS

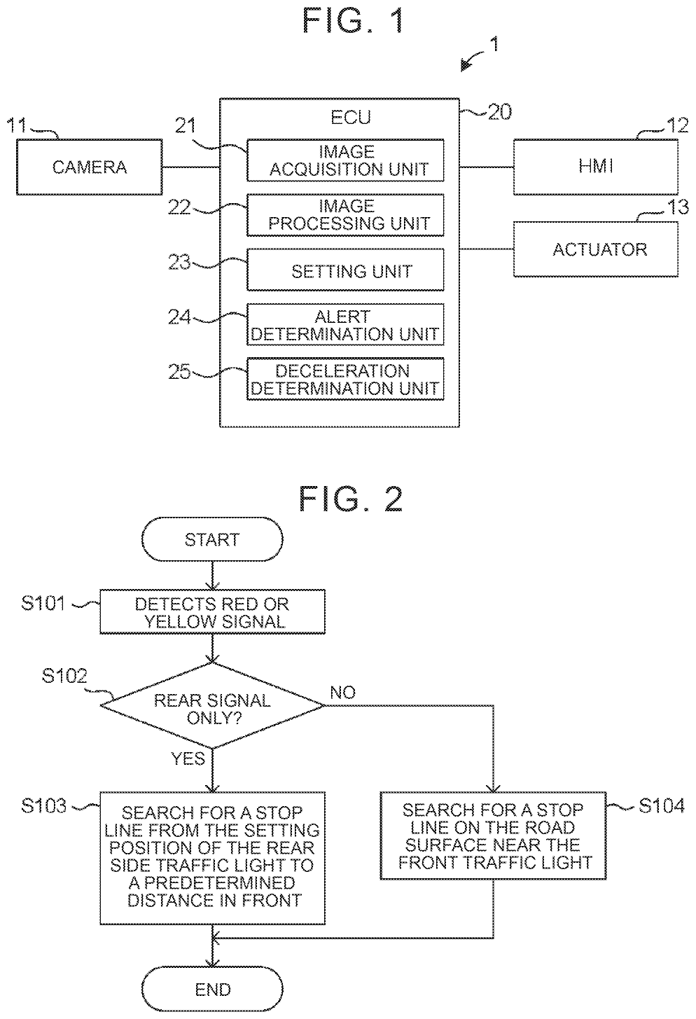

Embodiments of the stop line searching device will be described referring to FIG. 1 to FIG. 3B. Hereinafter, an Electronic Control Unit (ECU) 20 mounted on the vehicle 1 will be described as an exemplary stop line searching device.

In FIG. 1, a vehicle 1 includes a camera 11, a Human Machine Inter face (HMI) 12, an actuator 13, and an ECU 20.

The camera 11 is a camera for capturing an image in front of the vehicle 1. The camera 11 may be provided inside the vehicle cabin of the windshield of the vehicle 1. Note that the vehicle 1 may include other cameras in addition to the camera 11. That is, the vehicle 1 may include two or more cameras.

HMI 12 is an interface for inputting and outputting data between an occupant (for example, a driver) of the vehicle 1 and a system (for example, an ECU 20) of the vehicle 1. HMI 12 may include a display, a speaker, and the like. The display included in HMI 12 may be a HUD (Head Up Display) or a multi-information display provided in the instrument panel.

The actuator 13 includes a brake actuator. The brake actuator controls the brake system in response to a control signal from ECU 20, and controls a braking force applied to the wheels of the vehicle 1. The actuator 13 may include a steering actuator. The steering actuator controls driving of an assist motor that controls steering torque in the electric power steering system in response to a control signal from ECU 20. The actuator 13 may include a drive actuator. When the vehicle 1 is a vehicle including an engine, the drive actuator controls the amount of air supplied to the engine (for example, the throttle opening degree) in response to a control signal from ECU 20 to control the driving force of the vehicle 1.

ECU 20 includes an image acquisition unit 21, an image processing unit 22, a setting unit 23, an alert determination unit 24, and a deceleration determination unit 25, which are logically configured logical blocks or physically implemented processing circuitry.

The image acquisition unit 21 acquires an image obtained by the camera 11 capturing an image in front of the vehicle 1. The camera 11 repeatedly captures an image in front of the vehicle 1 at a predetermined imaging cycle. The image acquisition unit 21 may sequentially acquire a plurality of images captured by the camera 11.

The image processing unit 22 performs image processing on the image acquired by the image acquisition unit 21. The image processing unit 22 performs image processing on the image to detect a traffic light installed at an intersection in front of the vehicle 1. The image processing may include at least one of an edge extraction process, a noise removal process, and a pattern matching process.

The image processing unit 22 estimates the position of the detected traffic light. The position of the traffic light may be estimated based on the position of the traffic light in the image (in particular, the position in the height direction of the image) and the size of the traffic light in the image. The position of the traffic light may be estimated using imaging techniques such as Structure from Motion (SfM).

The image processing unit 22 determines the light state of the detected traffic light. The light state may include a passage permission state corresponding to a blue signal, a passage prohibition state corresponding to a red signal, and a transition state corresponding to a yellow signal. When the signal is a signal with an arrow light, the light state may include an arrow light state.

The image processing unit 22 generates traffic light information indicating the position of the detected traffic light and the lighting state of the traffic light. The setting unit 23 sets a stop line searching area for searching for a stop line when the lighting state of the traffic light indicated by the traffic light information is the passage prohibition state (i.e., red signal) or the transition state (i.e., yellow signal). Details of the stop line searching area will be described later.

When the stop line searching area is set by the setting unit 23, the image processing unit 22 performs image processing on a portion of the image corresponding to the stop line searching area, thereby detecting a stop line related to an intersection in front of the vehicle 1. The image processing may include at least one of an edge extraction process, a noise removal process, and a pattern matching process. Note that the stop line related to the intersection in front of the vehicle 1 may not be detected from the image captured by the camera 11. For example, a stopping line related to an intersection in front of the vehicle 1 may be detected based on a detection result of at least one of the radar sensor and Laser Imaging Detection and Ranging (LiDAR).

The alert determination unit 24 determines whether or not to alert the driver of the vehicle 1. The alert determination unit 24 may determine to issue an alert when the light state of the traffic light is the passage prohibition state (that is, the red signal) or the transition state (that is, the yellow signal), and when sudden braking is required to stop the vehicle 1 at the position of the detected stop line. ECU 20 may then control HMI 12 to view alert images or to issue alerts.

The deceleration determination unit 25 determines whether or not the vehicle 1 needs to be decelerated when the light state of the traffic light is the passage prohibition state (that is, the red signal) or the transition state (that is, the yellow signal). The deceleration determination unit 25 may calculate a required deceleration required for the vehicle 1 to stop at the position of the stop line based on the distance from the current position of the vehicle 1 to the position of the detected stop line and the speed of the vehicle 1. When the current deceleration of the vehicle 1 is smaller than the required deceleration, the deceleration determination unit 25 may determine that the deceleration of the vehicle 1 is necessary. Here, ECU 20 may control the actuator 13 such that the deceleration of the vehicle 1 approaches the required deceleration. It should be noted that ECU 20 may be configured to be capable of executing automated driving for automatically controlling at least one of acceleration/deceleration and steering of the vehicle 1 by controlling the actuator 13.

Next, the stop line searching area set by the setting unit 23 will be described. When a stop line is detected from an image captured by the camera (for example, the camera 11), for example, at least one of a road surface marking having a shape similar to the shape of the stop line, a shadow extending along the direction in which the stop line extends, and a cut of the road pavement extending along the direction in which the stop line extends may be erroneously recognized as the stop line. If a line that is not a stop line is erroneously recognized as a stop line, there is a possibility that, for example, at least one of an unwanted alert and a deceleration of the vehicle 1 may be performed, affecting the determination result of at least one of the alert determination unit 24 and the deceleration determination unit 25.

Since the stop line is provided according to a predetermined rule, the position of the stop line can be narrowed down from the position of the traffic light. Focusing on this point, the setting unit 23 sets the stop line searching area based on the position of the traffic light indicated by the traffic light information. In the following description, among traffic lights that restrict the travel of the vehicle 1, traffic lights installed at the rear side of the intersection as viewed from the vehicle 1 are referred to as “rear side traffic lights”. In addition, among traffic lights for regulating the travel of the vehicle 1, traffic lights installed on the front side of the intersection as viewed from the vehicle 1 are referred to as “front side traffic lights”.

Specifically, in the flow chart of FIG. 2, when the lighting state of the traffic light indicated by the traffic light information is the passage prohibition state (that is, the red signal) or the transition state (that is, the yellow signal) (S101), the setting unit 23 determines whether or not only the rear-side traffic light is installed at the intersection in front of the vehicle 1 based on the position of the traffic light indicated by the traffic light information (S102).

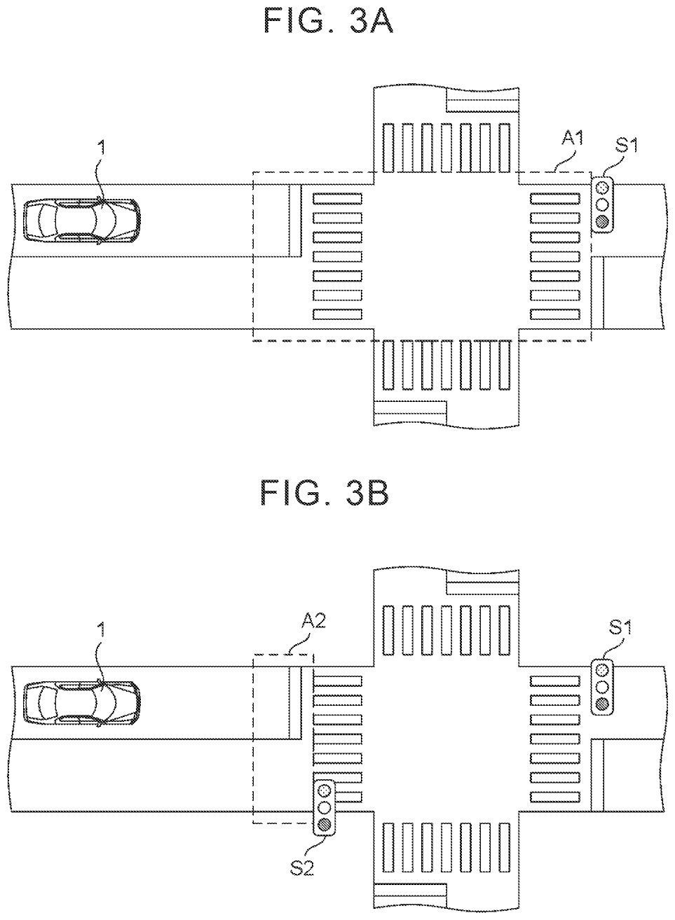

In S102 process, when it is determined that only the rear-side traffic light is installed (S102: Yes), the setting unit 23 sets, as the stop line searching area, an area (for example, refer to the area A1 in FIG. 3A) extending from the installation position of the rear-side traffic light (for example, refer to the traffic light S1 in FIG. 3A) to the vehicle 1 side (for example, S103). Here, the length of the area A1 in the approach direction in which the vehicles 1 enter the intersection may be, for example, 30 meters.

In S102 process, when it is determined that the front-side traffic light is installed in addition to the back-side traffic light (S102: No), the setting unit 23 sets a region near the installation position of the front-side traffic light (for example, refer to the traffic light S2 in FIG. 3B) (for example, refer to the area A2 in FIG. 3B) as the stop line searching area (S104). Here, the length of the area A2 in the approach direction in which the vehicles 1 enter the intersection may be several meters.

### Technical Effect

For example, as shown in FIGS. 3A and 3B, the distance from the traffic light S1 corresponding to the rear traffic light to the stop line and the distance from the traffic light S2 corresponding to the front traffic light to the stop line differ from each other. If the size of the stop line searching area is fixed, the following technical problem arises. When the size of the stop line searching area is relatively small and only the rear-side traffic light is installed at the intersection, there is a possibility that the stop line searching area does not include the stop line. In this case, there is a possibility that the stop line is not detected, or something different from the stop line is erroneously recognized as the stop line. When the size of the stop line searching area is relatively large and the near-side traffic light is installed at the intersection, the stop line searching area may include a stop line and a shape similar to the shape of the stop line. In this case, instead of the stop line, a stop line having a shape similar to the shape of the stop line may be erroneously recognized as the stop line.

On the other hand, the setting unit 23 changes the size of the stop line searching area between a case in which only the rear-side traffic light is installed at the intersection and a case in which the front-side traffic light is installed at the intersection. Therefore, according to ECU 20 as an exemplary stop line searching device, it is possible to appropriately search for a stop line.

### First Modification

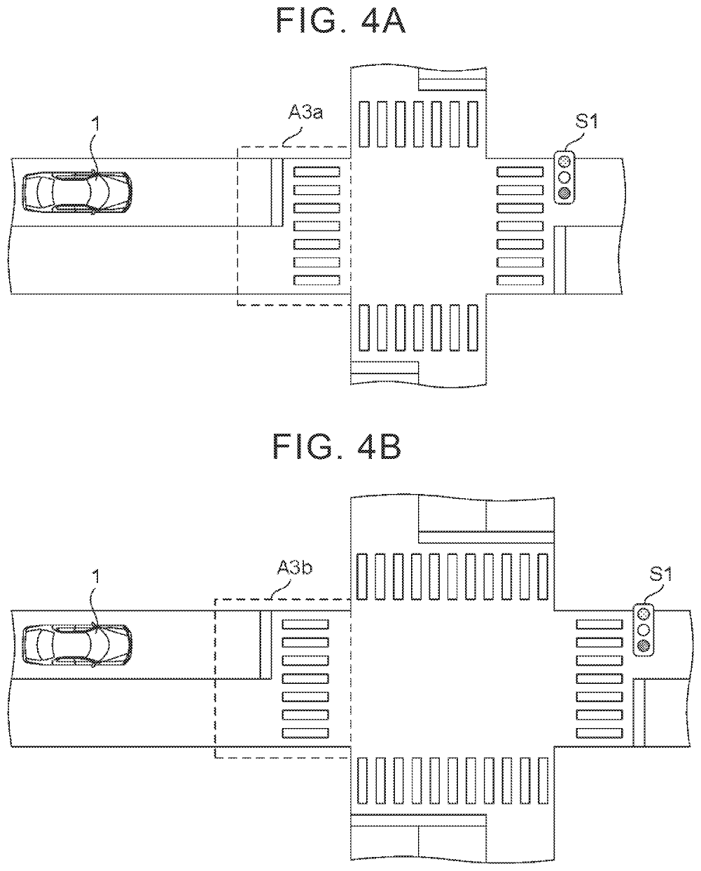

A first modification of the embodiment of the stopping line searching device will be described referring to FIGS. 4A and 4B. As shown in FIGS. 4A and 4B, the distance from the end of the vehicle 1 side of the road extending in the intersecting direction to the stopping line changes according to the number of lanes extending in the intersecting direction (the vertical direction of FIGS. 4A and 4B) which intersects the approach direction (the lateral direction of FIGS. 4A and 4B) in which the vehicle 1 enters the intersecting direction. Specifically, as the number of lanes extending in the intersecting direction increases, the distance from the end portion of the road extending in the intersecting direction on the vehicle 1 side to the stop line increases.

In S102 process of the flow chart shown in FIG. 2, when it is determined that only the rear-side traffic light is installed (S102: Yes), the setting unit 23 may set the stopping line searching area on the basis of the number of lanes extending in the intersecting direction intersecting the approach direction in which the vehicle 1 enters the intersection. In this case, the setting unit 23 may set the region extending toward the vehicle 1 side (the area A3a in FIG. 4A, see the area A3b in FIG. 4B) as the stopping line searching area starting from the end portion on the vehicle 1 side of the road including the lane extending in the intersecting direction. The number of lanes extending in the intersecting direction may be obtained from the map information.

As shown in FIGS. 4A and 4B, the length of the area A3b in the approach direction in which the vehicles 1 enter the intersection is longer than the length of the area A3a in the approach direction. That is, the length of the stop line searching area in the approach direction when the number of lanes extending in the intersecting direction is relatively large is longer than the length of the stop line searching area in the approach direction when the number of lanes extending in the intersecting direction is relatively small.

For example, if a right turn dedicated lane is provided, a guide line for a right turn vehicle may be drawn in the intersection. When an intersection is included in the stop line searching area, at least a part of the guide line may be erroneously recognized as a stop line. On the other hand, as described above, if the region extending toward the vehicle 1 side is set as the stop line searching area starting from the end portion on the vehicle 1 side of the road including the lane extending in the intersecting direction, it is possible to suppress at least a part of the guide line from being erroneously recognized as the stop line. Therefore, according to the first modification, it is possible to search for the stop line more appropriately.

### Second Modification

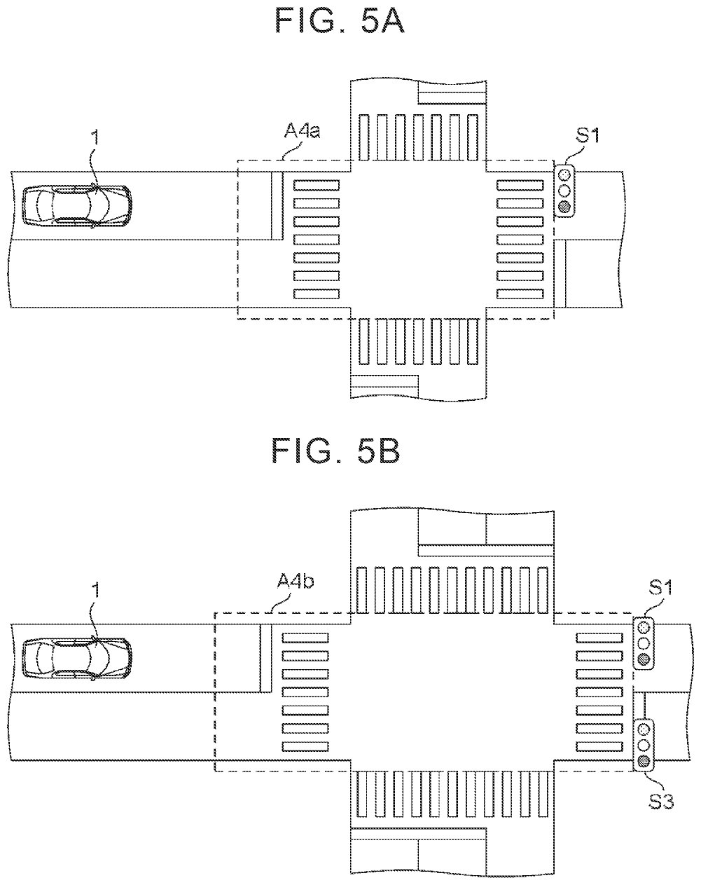

A second modification of the embodiment of the stopping line searching device will be described referring to FIGS. 5A and 5B. As shown in FIGS. 5A and 5B, when the intersection is relatively wide (see FIG. 5B), the number of traffic lights installed at the intersection is larger than when the intersection is relatively narrow (see FIG. 5A). At the intersection shown in FIG. 5A, only the traffic light S1 is installed as a traffic light for regulating the traveling of the vehicles 1. On the other hand, at the intersection shown in FIG. 5B, traffic lights S1 and S3 are installed as traffic lights that restrict the traveling of the vehicles 1.

In S102 process of the flow chart shown in FIG. 2, when it is determined that only the rear-side traffic light is installed (S102: Yes), the setting unit 23 may set the stopping line searching area (the area A4a of FIG. 5A, see the area A4b of FIG. 5B) based on the number of the rear-side traffic light. As shown in FIGS. 5A and 5B, the length of the area A4b in the approach direction in which the vehicles 1 enter the intersection is longer than the length of the area A4a in the approach direction.

With this configuration, the stop line searching area can be set to include the stop line. Therefore, according to the second modification, the stop line can be searched more appropriately.

Aspects of the disclosure derived from the above-described embodiments and modifications are described below.

A stop line searching device according to an aspect of the disclosure includes: an image acquisition unit that acquires an image obtained by capturing an image of a front side of an own vehicle; a traffic light detection unit that detects a traffic light installed at an intersection in front of the own vehicle based on the image; and a setting unit that sets a stop line searching area for searching for a stop line related to the intersection based on a detection result indicating whether or not a front side traffic light on a front side of the intersection as viewed from the own vehicle is detected by the traffic light detection unit when a rear side traffic light on a rear side of the intersection as viewed from the own vehicle is detected by the traffic light detection unit. In the above-described embodiment, ECU 20 corresponds to an example of the stop line searching device, the image acquisition unit 21 corresponds to an example of the image acquisition unit, the image processing unit 22 corresponds to an example of the traffic light detection unit, the setting unit 23 corresponds to an example of the setting unit, and the traffic light information corresponds to an example of the detection result.

In the stop line searching device, when the rear-side traffic light is detected by the traffic light detection unit and the detection result indicates that the front-side traffic light is not detected, the setting unit may set the stop line searching area based on the number of lanes extending in an intersecting direction intersecting an approach direction in which the host vehicle enters the intersection at the intersection.

In this case, the setting unit may set a region extending toward the host vehicle side as the stop line searching area starting from an end portion on the host vehicle side of a road including a lane extending in the intersecting direction.

Alternatively, in the stop line searching device, when the rear-side traffic light is detected by the traffic light detection unit and the detection result indicates that the front-side traffic light is not detected, the setting unit may set the stop line searching area based on the number of the rear-side traffic light.

The present disclosure is not limited to the above-described embodiments, and can be modified as appropriate within the scope and spirit of the disclosure that can be read from the claims and the entire specification, and a stop line searching device with such a change is also included in the technical scope of the present disclosure.

What is claimed is:

1. A stop line searching device comprising:
an image acquisition unit for acquiring an image obtained by photographing an area in front of an own vehicle;
a traffic light detection unit for detecting a traffic light installed at an intersection in front of the own vehicle based on the image; and
a setting unit for setting a stop line searching area for searching for a stop line for the intersection, based on a detection result indicating whether a closer-side traffic light on a closer side of the intersection as viewed from the own vehicle is detected by the traffic light detection unit, when a further-side traffic light on a further side of the intersection as viewed from the own vehicle is detected by the traffic light detection unit.

2. The stop line searching device according to claim 1, wherein when the further-side traffic light is detected by the traffic light detection unit, and the detection result indicates that the closer-side traffic light is not detected, the setting unit sets the stop line searching area based on the number of lanes extending in an intersecting direction intersecting a travel direction in which the own vehicle enters the intersection.

3. The stop line searching device according to claim 2, wherein the setting unit sets an area extending toward the own vehicle side as the stop line searching area using an end portion, on the own vehicle side, of a road including a lane extending in the intersecting direction as a starting point.

4. The stop line searching device according to claim 1, wherein when the further-side traffic light is detected by the traffic light detection unit, and the detection result indicates that the closer-side traffic light is not detected, the setting unit sets the stop line searching area based on the number of the further-side traffic lights.
